(19) United States
(12) Patent Application Publication
(10) Pub. No.: US 2009/0107602 A1
(43) Pub. Date: Apr. 30, 2009

(54) Self-inflating tire valve

(76) Inventor: Vladimir M. Kabakov, Arlington, VA (US)

Correspondence Address: Vladimir M. Kabakov, Apt. 1201, 4600 S. Four Mile Run Drive, Arlington, VA, 22204, US

(21) Appl. No.: 12/076,881

(22) Filed: Mar. 25, 2008

Related U.S. Application Data
(63) Continuation-in-part of application No. 11/979,076, filed on Oct. 31, 2007.

(51) Int. Cl. B60C 23/00

(52) U.S. Cl. 152/427

(57) ABSTRACT

Small air pumping devices are mounted directly in the conventional tire valves to keep the vehicle's tires properly inflated without requiring the user's attention. If a tire is beginning to become under-inflated, a pumping piston having a single check valve is moved reciprocally in the tire valve stem by the cyclical deformation of the tire during the vehicle's travelling. The ambient air is pumped into the tires through the tire valves. The tire valves incorporating the pumping devices are kept using in a regular manner for reliably preventing air escaping from the tires and for inflating the tires from the external sources. Such “self-inflating” tire valves may be mounted as the regular tire valves both in new manufactured vehicles or in used vehicles without any modifications in the vehicle's axes, wheels or tires and without the necessity to make additional openings in the wheel.

### BACKGROUND OF THE INVENTION

1. Cross-Reference to Related Applications

The present application is a continuation-in-part of application Ser. No. 11/979076 filed on Oct. 31, 2007 which is now copending.

2. Field of the Invention

This invention relates to methods and apparatus for keeping a vehicle's tires properly inflated, and more particularly, it pertains to a tire valve including a pumping device which maintains the tire properly inflated by automatically pumping small amounts of ambient air when the tire beginning to become under-inflated.

3. Technical Background

Vehicle's tires are designed to be used at the air pressure specified by the manufactures to optimize the performance and fuel economy, to maximize tire life, and for driving safety.

However, pneumatic tires can be subject to slow leaks of inflation air. Because of various “natural” sources of leaks, such as permeability of the tire material, not hermetical joints between the tire and rim, etc., the air pressure in a tire can reduce during the vehicle's operation as much as one psi per month, even without a puncture of the tire by a foreign object such as a nail. It's for this reason that the air pressure in the tire needs to be checked regularly by vehicle owners and air periodically added from an external sources.

Advances in technology have resulted in improvement of tire pressure stability under normal operating conditions with negligible air leakage. Hence, operators often tend not to checking air pressure regularly. A survey provided by the National Highway Traffic Safety Administration (NHTSA) shows that only 4% of respondents checked the pressure as part of their routine maintenance. As a result, the under-inflation of tires is considered the most common car problem today. According to this NHTSA, about 30% of all vehicles have at least one tire that is 8 psi or more under-inflated. About 5% have all four tires seriously under-inflated.

Tire pressure directly impacts fuel efficiency. Under-inflated tires have a higher rolling resistance, this results in increased fuel consumption. Under-inflated tires can cut fuel economy by 2% per pound. For example, if the tires should be at 32 psi and they are actually at 27 psi, the mileage is reduced by 10%. According to the U.S. Department of Energy, under-inflated tires are responsible for nearly 3.3 million gallons of wasted gasoline each and every day.

The under-inflation of tires also impairs steerability and degrades driving safety. The under-inflated, “soft” tires affect cornering and traction. Furthermore, the reduced footprint results in additional wear of the tires. This not only raises the operational cost of the vehicle but also is very important for safe driving. Hence, maintaining correct air pressure in a vehicle's tire is very important.

Prior art pressure maintenance efforts are known focused on different systems for adding small amounts of air while the tire rotates to compensate for losses due to leaks. Numerous tire pressure maintaining system have been invented. For example, U.S. Pat. Nos. 4,269,252 to Shapiro, 4,349,064 to Booth, 4,840,212 to Wei, 5,355,924 to Olney, 5,556,489 to Curlett et al., 5,558,730 to Olney, 5,975,174 to Loewe, 7,013,931 to Toit, 7,117,731 to Hrabal disclose various types of air pumps disposed within the tire. Unfortunately, such devices have a limited practical usage. An important reason of that is a necessity of considerable changes in the design of the wheels, tires, tire inlet valves, etc. or/and to provide openings and valves in addition to the conventional tire inlet valves, such as Schruder type or Presta type, which are proved to be reliable for many years of using. Any additional openings in the vehicle's rim with the valves that are supposed to be used not only for preventing the air escaping from the tire but also for pumping the air into the tire can reduce the reliability of the system. Furthermore, most of the prior art air pumping systems are too complex to be workable.

This invention seeks to overcome the deficiencies of the known tire pressure maintenance systems and benefit from the advantages that may be expected from the knew method and apparatus.

### BRIEF SUMMARY OF THE INVENTION

The principal objects of the present invention is to reduce fuel consumption, tire wearing and to improve driving safety of a vehicle by keeping the tires fully inflated at a correct pressure at all times without requiring the user's attention. This has to be achieved by using a new type of tire valves which are not only used for inflating the tire from the external sources and for preventing air escaping from the tire, but also keep the tires properly inflated during the vehicle's operation.

When the tire is beginning to become under-inflated, the ambient air is pumping into its interior by a small pumping device which is mounted directly into the standard tire valve having a conventional tire valve core. The devices includes a piston with a single check valve and is operated during the movement of the vehicle by the cyclical deformations of the tire only if the tires are under-inflated. A lever system serves as means for transferring such a cyclical tire deformation to the reciprocating piston in the pumping device. Each time when the portion of such a tire incorporating the tire valve is deformed by the vehicle's weight against the road surface, the piston is moved in the cylindrical bore of the valve stem against the force of a compression spring. After contacting this part of the tire with the road, the tire shape is restored and the piston is pushed back by the spring.

During the piston's reciprocating movement, the valve actuator can be engaged or disengaged with the piston, so that the valve core can be opened when that reciprocating movement can exceed a predetermined limit if the tire is under-inflated. During the intake stroke, the ambient air is drawn into a cylindrical bore, made in the tire valve stem body.

During the compression stroke, the air is compressed by the compression spring after the valve core is closed and is expelled into the tire interior. It happens during each rotation of the wheel only if the tire is under-inflated and the vehicle accelerates a sufficient speed.

In the preferred embodiment of the invention, the levers are automatically pivoted in a safety position, so that they can not be broken or to damage the tire in the case of an accident when the tire is flattened.

The present self-inflating tire valve can be incorporated not only into new manufactured vehicles but also into existing vehicles without necessity of modification of axles, wheels, or tires and without making any additional openings in the wheel for pumping the air into the tire.

The embodiment shown in the accompanying drawings is illustrative only. Attention being called to the fact that changes may be made in the specific construction while yet remaining within the scope of the appended claims.

### BRIEF DESCRIPTION OF THE DRAWINGS

FIG. 1′ is a cross-sectional view of a vehicle's wheel with a tire valve in accordance with the preferred embodiment of the invention.

FIG. 2′ is an enlarged cross-sectional view of the tire valve and the lever system shown in FIG. 1.

FIG. 3′ is a cross-sectional view taken along line III-III in FIG. 2′.

FIG. 4′ is the same view of the preferred embodiment of the invention as shown in FIG. 1′ when the tire is under-inflated and the part of the tire incorporating the tire valve is deformed being in contact with the road while the vehicle is traveling with a preselected speed.

FIG. 5′ is a cross-sectional view of a vehicle's wheel with a tire valve in accordance with an alternative modification of the preferred embodiment of the invention.

FIG. 6′ is the same view of the alternative modification of the preferred embodiment of the invention shown in FIG. 5′ when the tire is under-inflated and the part of the tire incorporating the tire valve is deformed being in contact with the road while the vehicle is traveling with a preselected speed.

### DETAILED DESCRIPTION OF THE INVENTION

A tire valve incorporated with the pumping device for automatically maintaining the tire inflation in a vehicle's wheels will become apparent from the following description taken in conjunction with presently preferred embodiment thereof with reference to the accompanying drawings. The identical details in all the drawings have the same designations.

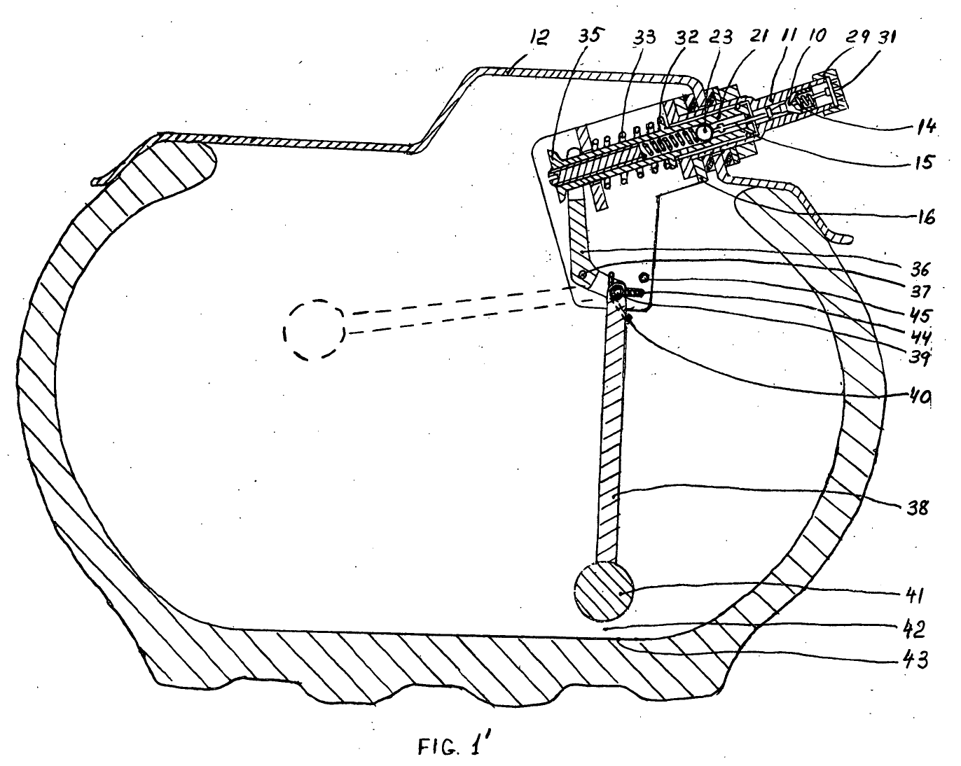

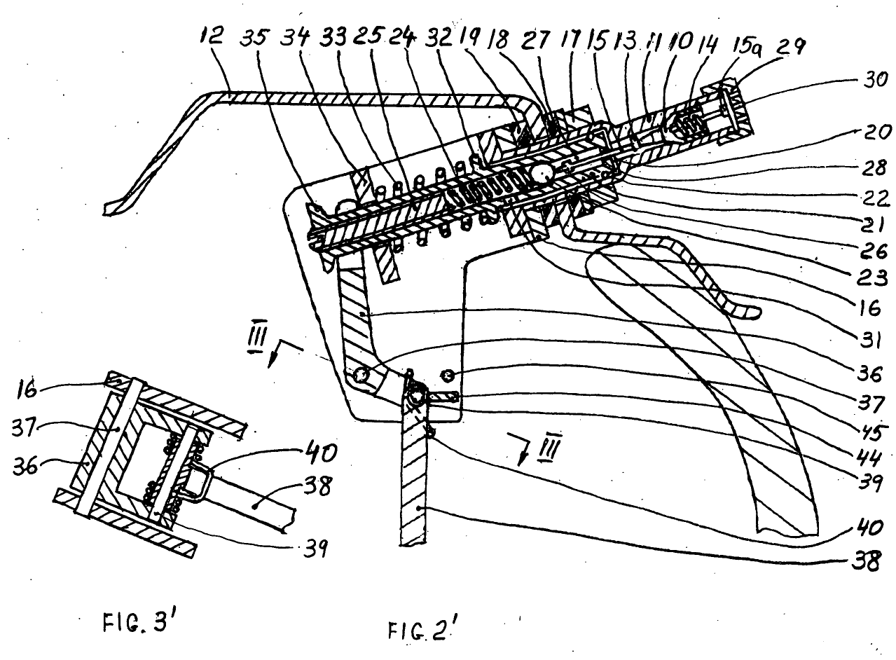

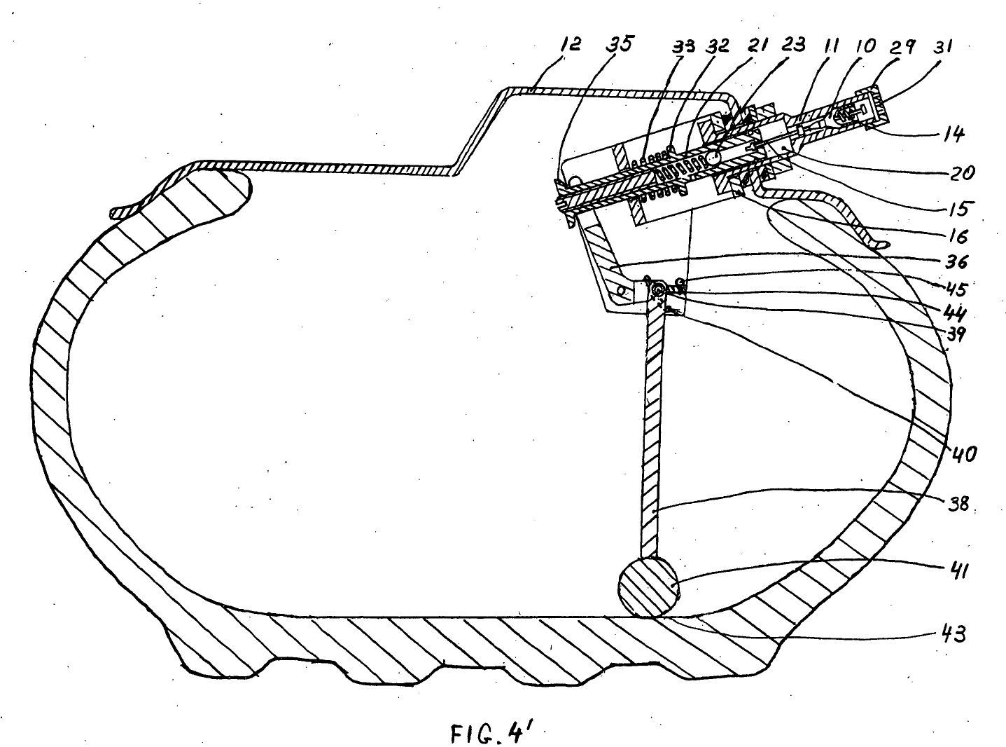

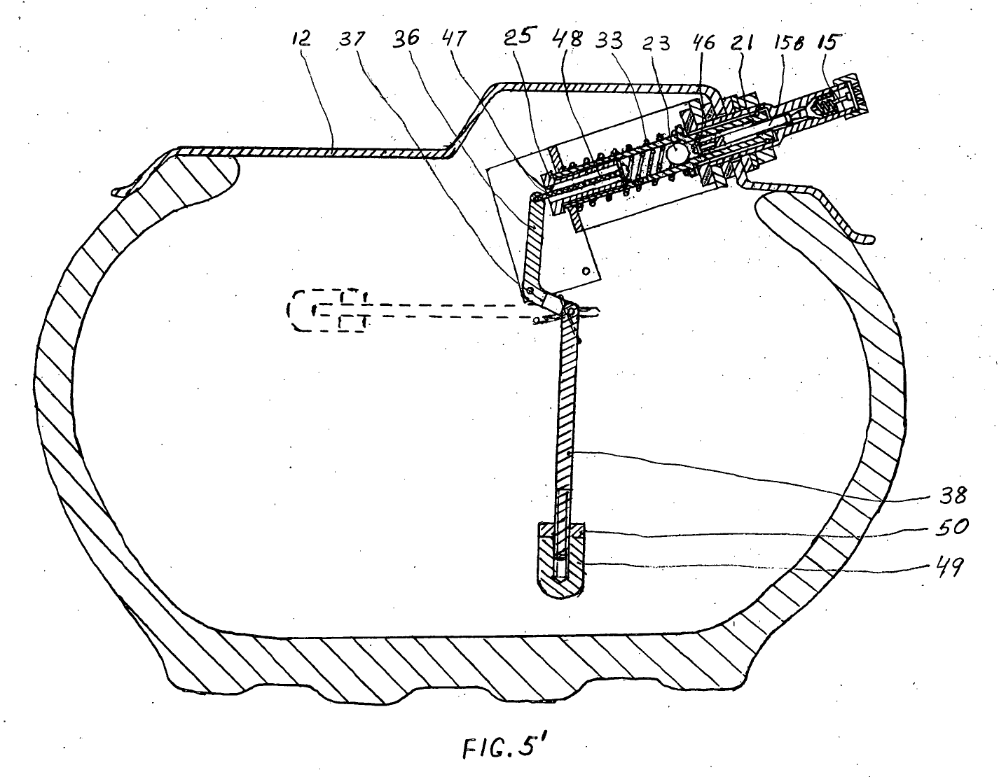

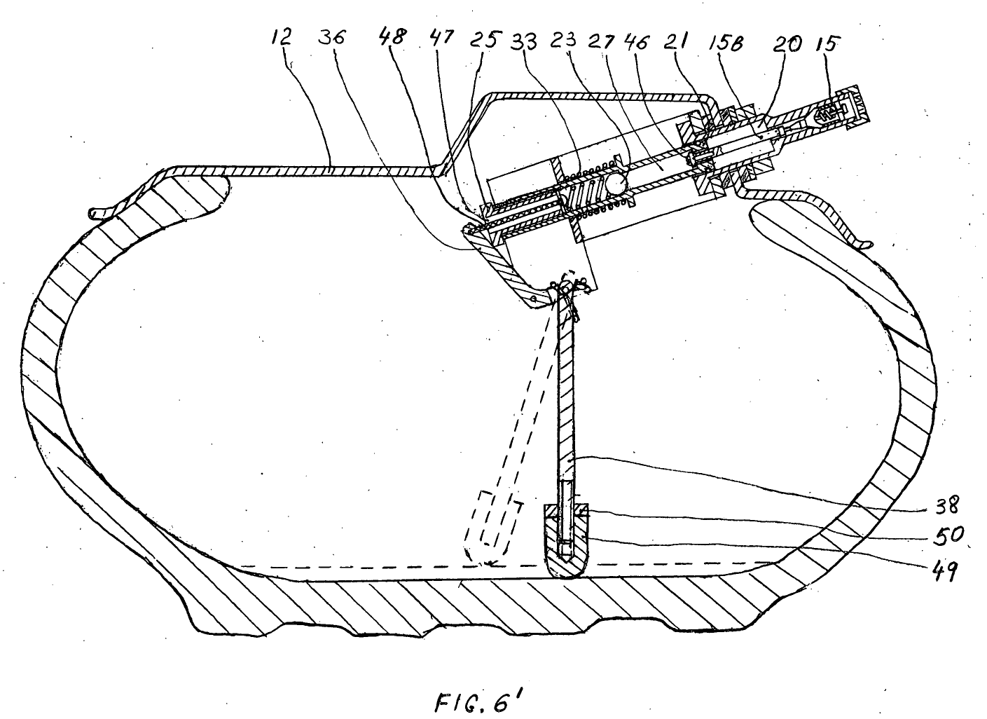

Turning to FIGS. 1′-4′, the preferred embodiment of the invented tire valve includes a conventional valve core 10, such as a Schruder type, disposed within a valve stem 11 which is mounted on the wheel rim 12. The valve core 10 includes a seal 13, a spring 14 and a valve actuator 15. The outer end 15a of the actuator is supposed to be pressed by a consumer to open the tire valve for inflating the tire from an external source (not shown). The tire valve is fixed to the wheel's rim 12 together with a bracket 16 by a nut 17 through the sealing rings 18 and 19.

The valve stem 11 is provided with a cylindrical bore 20 wherein a piston 21 is slidably mounted. The piston 21 includes at least one sealing o-ring 22 and a check valve 23 having a spring 24 which can be adjusted by a screw 25. There is a stopper 26 on the inner end of the valve actuator 15 which is disposed inside of an axial channel 27 in the piston 21. Because the size of the opening 28 at the end of the piston 21 is smaller than the diameter of the axial channel 27, the piston 21 can be moved along the central axis in the cylindrical bore 20 without engaging with the valve actuator 15 until the stopper 26 reaches to the end of the axial channel 27. After that the valve actuator 15 will be engaged by the piston 21 and pulled to open the valve core 10. Any means such as spring latches, threads, special configurations of the stopper 26 and opening 28, elastic material etc. can be used for penetrating of the stopper 26 into the axial channel 27 during assembling of the tire valve and for preventing the stopper 26 from going out of the axial channel 27 through the opening 28 during the valve operation.

A tire valve cap 29 is provided with holes 30 which are small enough to block road grit and particles but large enough to allow the ambient air to pass into the valve stem 11. There is an opening 31 in the piston's body for air communication between the check valve 23 an the tire interior. The piston 21 has a circular rib 32 which is pressed by a compression spring 33. The other end of the spring 33 is biased against the support 34 which is fixed in the bracket 16. There is another ring 35 on the end of the piston 21 which can be pressed by the forked end of the the lever 36 pivotally mounted on the axis 37 in the bracket 16.

A push rod 38 is pivotally mounted on the axis 39 which is fixes on the other forked end of the lever 36. A torsional spring 40 causes the push rod 38 to be pivoted around the axis 39 clockwise into a position shown in FIG. 1′ in dotted lines. When the wheel's rotation exceeds a predetermined speed the push rod 38 is pivoted by the centrifugal force into a substantially radial position relative to the wheel, as shown in FIG. 1′ in solid lines. A weight 41 can be disposed on the end of the push rod 38. When the tire is inflated properly, there is a gap 42 between the radially oriented push rod 37 and the inner peripheral tire surface 43. The piston 21, the bracket 16, the lever 36 and the push rod 38 can be made from various materials such as metals or plastics.

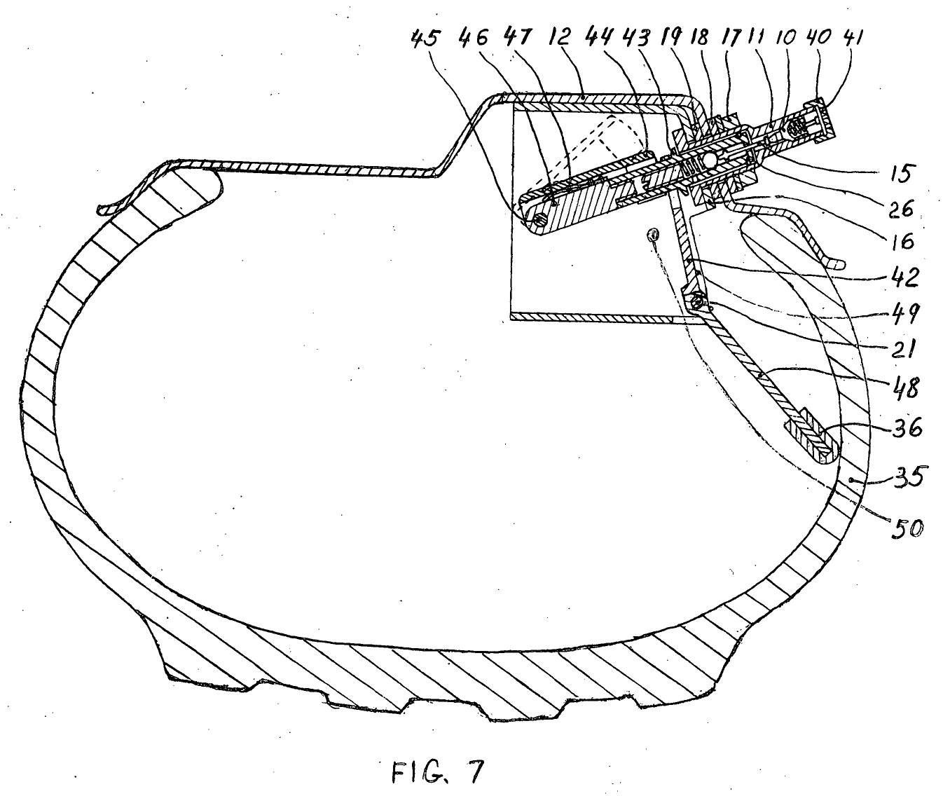

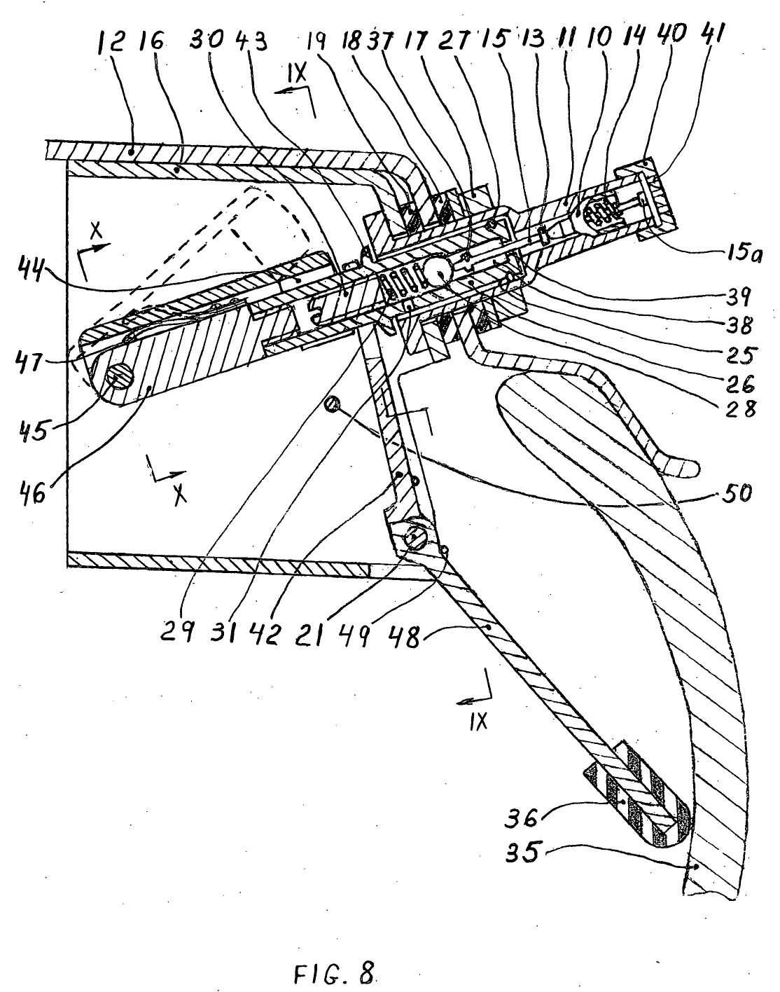

During the vehicle's travelling, each time when the portion of the tire incorporating the tire valve comes into contact with the road it is deformed by the vehicle's weight. If the tire is inflated properly, as shown in FIG. 1′, the tire deformation is not enough to overcome the gap 42 and to press the push rod 38 by the peripheral surface 43 even if the push rod 38 is oriented radially. If the tire is under-inflated and the vehicle is traveling with a sufficient speed, the inner peripheral tire surface press the push rod 38, as shown in FIG. 4′. The lever 36 is pivoted around the axis 37 counter-clockwise by the upper end of the push rod 38. As a result, the piston 21 is moved by the forked end of the lever 36 in the cylindrical bore 20 from the position shown in FIG. 1′ to the position shown in FIG. 4′ against the force of the compression spring 33. The air pressure in the cylindrical bore 20 is reduced until the tire valve core 10 and the check valve 23 are kept closed. At the end of the piston's movement, the valve activator 15 is pulled by the stopper 36 to open the valve core 10. The ambient air is drawn through the holes 30 in the cap 29 and through the open seal 13 of the valve core 10 into the cylindrical bore 20.

A stopper 45 restricts the movement of the push rod 38 after the valve core 10 is opened. When the safety pin 44 presses the stopper 45 the push rod 38 is declined from the radial position.

After contacting with the road, the deformed part of the tire restores its shape. As a result, the piston 21 is pushed back to the position shown in FIG. 1′ by the compression spring 33. This backward movement of the piston 21 can occur during the period of the wheel rotation before the next contact of this tire part with the road. At the beginning of this movement the valve core 10 is closed and after that the air in the cylindrical bore 20 is compressed and expelled through the check valve 23 into the tire interior when the pressure in the cylindrical bore 20 exceeds the air pressure in the tire.

While the vehicle keeps traveling, these movements of the piston 21 are repeated each time when the tire portion incorporating the tire valve is in contact with the road, so that the ambient air is successively drawn into the cylindrical bore 20 through the valve core 10 and expelled through the check valve 23 into the tire interior until it is inflated properly.

Each intake stroke of the piston 21 is driven by the tire deformation and consists of two successive steps. During the first step, the valve core 10 and the check valve 23 are closed. As a result, the pressure in the cylindrical bore 20 is reduced. During the second step, the cylindrical bore 20 is filled with the ambient air through the opened seal 13 of the valve core 10.

Each compression stroke, which is driven by the force of the compression spring 23, also consists of two successive steps. During the first step, the valve core 10 is being closed. This step should be as short as possible to reduce escaping the air from the cylindrical bore 20 through the valve core 10 before it is closed. During the second step, the air is compressed in the cylindrical bore 20 and is expelled into the tire interior through the check valve 23.

Because the tire valve core 10 remains open for a short period when the ambient air is drawn into the tire valve during the intake stroke when the check valve 21 is closed, reliability of the conventional tire valve for preventing air escaping from the tire can not be reduced.

The valve core 10 can be opened only if the tire is under-inflated and the vehicle is accelerated to a sufficient speed for developing the centrifugal force which can pivot the push rod 38 against the force of the torsional spring 40 to the radial position.

If the vehicle is stopped or is moving with a low speed the push rod 38 is pivoted by the torsional spring 40 in a position shown in FIG. 1′ in dotted lines, so that the push rod 38 can not be pressed by the deformed inner peripheral tire surface. The valve core 10 remains closed even if the tire is under-inflated and the tire portion incorporating the tire valve is in contact with the road.

If the tire is flattened as a result of an accident, the push rod 38 is pivoted clockwise by the deflating tire into a substantially horizontal position. In this position, it can not be broken or cause a damaging to the tire. During the reinflation of the repaired tire, the push rod 38 is automatically pivoted into the operating position.

The tire valve can be opened for inflating the tire from an external source in a regular manner by pressing the outer end 15a of the valve actuator 15. In this case, the check valve 23 is also opened either directly by the inner end of the actuator 15 or by the high air pressure developed by the external source of the tire inflation.

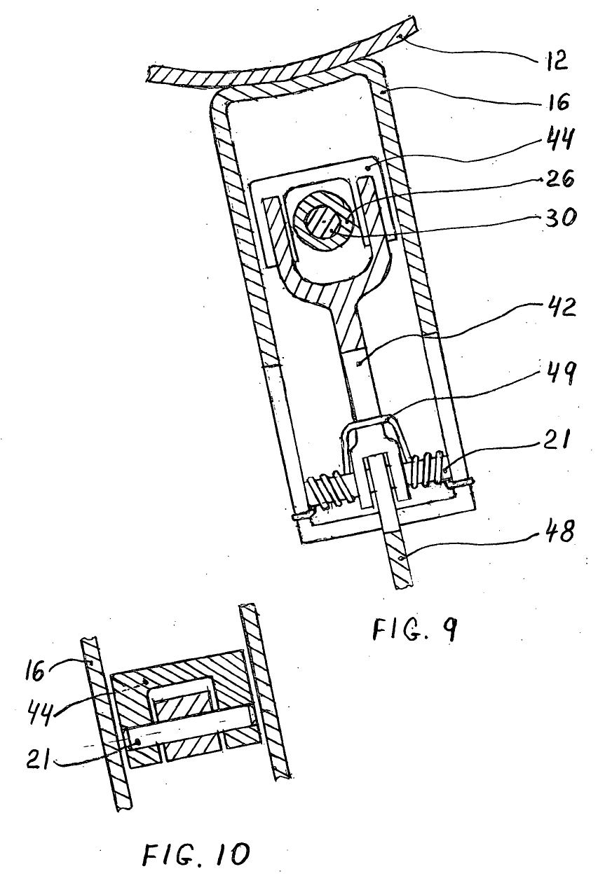

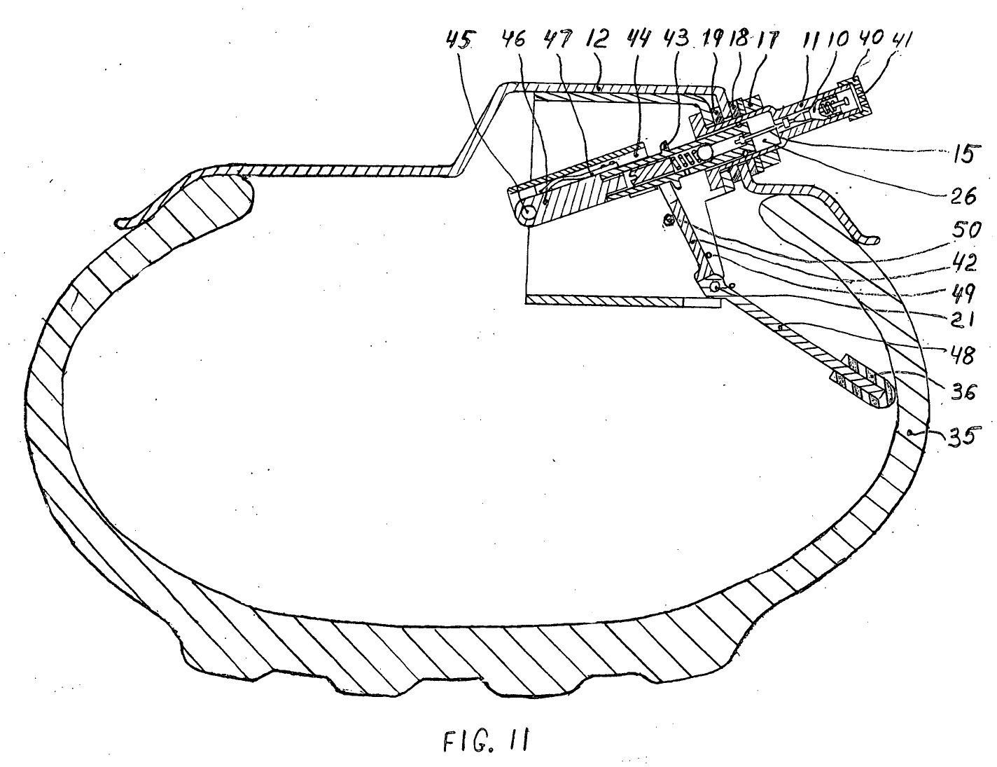

In an alternative modification of the preferred embodiment of the invention, shown in FIGS. 5′ and 6′, the diameter of the extension 15b of the actuator 15 is substantially close to the diameter of the axial channel 27 in the piston 21. Therefore during the compression stroke of the piston 21, the air is expelled into the tire not only from the cylindrical bore 20 in the valve stem 11 but also from the axial channel 27 in the piston 21. During the assembling of the tire valve, a screw 46 can be screwed in the end of the actuator extension 15b so that the head of the screw 46 (or a washer between the screw and the actuator extension 15b) could serve as a stopper 26 for engaging the actuator 15 by the moving piston 21 and opening the valve core 10.

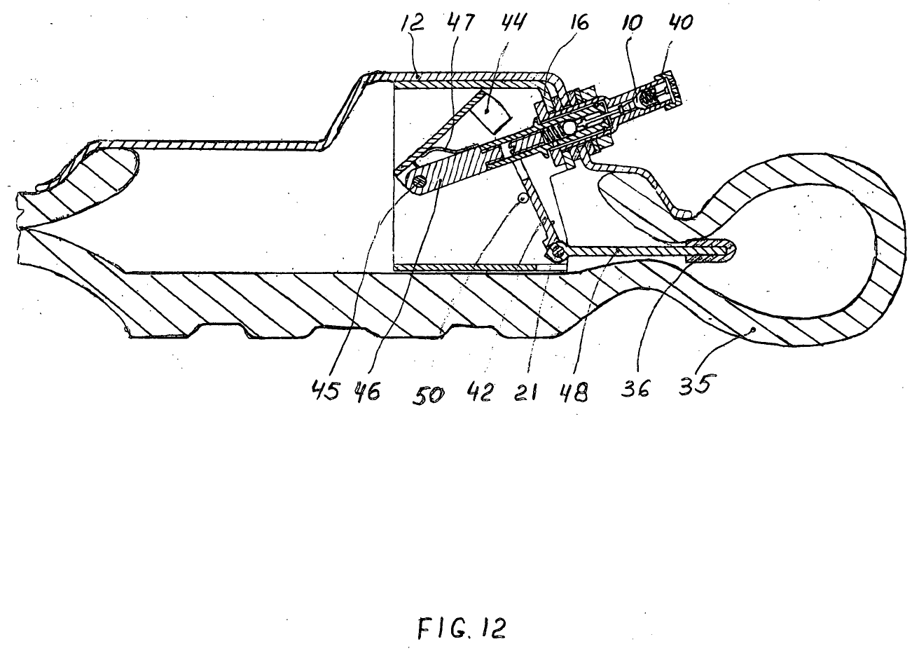

The adjusting screw 25 in the piston 21 has an axial bore 47 wherein a flexible cable (or optionally a solid pivotable link) 48 is disposed. One end of the cable 48 is fixed at the inner end of the screw 25, the other end of the cable 48 is fixed to the lever 36. When the push rod 38 is pushed up by the deformed tire, the lever 36 is pivoted around the axis 37 and pulls the cable 48. As a result, the piston 21 is moved from the position shown in FIG. 5′ into the position shown in FIG. 6′ against the force of the spring 33. During the compression stroke, the lever 36 is pulled by the cable 48 and is pivoted back into the position of FIG. 5′. A shoe 49 is screwed on the end of the push rod 38 so that the length of the push rod 38 can be adjusted and fixed by a nut 50.

While this invention has been described with reference to the structure disclosed herein, it is merely exemplary. The preferred embodiment of the present invention is described herein in details to thereby better enable others skilled in the art to utilize this invention. They are subject to many different variations in structure, design, application and methodology. It is to be understood that the details herein are to be interpreted as illustrative and not in a limiting sense. For example, various systems and mechanisms can be used for opening and closing the tire valve core by acting of the reciprocating elements of the air pumping means. The invention is intended to cover any modifications, which may be variously practiced within the scope of the following claims or their legal equivalents, rather than by examples given.

What is claimed is:

1. A method of automatically maintaining a vehicle's wheel tire properly inflated, said wheel comprising a conventional tire valve used in a regular manner for preventing air escaping from the tire and for inflating the tire from an external source, said conventional tire valve including a valve core disposed in a valve stem, said valve core including a valve actuator for opening and closing said valve core, said valve actuator including an outer end and an inner end, said method including:
disposing reciprocating air pumping means in said conventional tire valve;
automatically pumping the ambient air into the tire through said conventional tire valve;
engaging and disengaging said valve activator by said pumping means for automatically opening and closing said tire valve core during the air pumping process;
controlling the opening of the tire valve depending on the degree of the tire inflation.

2. The method of automatically maintaining a vehicle's wheel tire properly inflated as defined in claim 1, further including:
providing the valve stem of said conventional tire valve with an axial cylindrical bore;
disposing a pumping piston in said axial cylindrical bore, said pumping piston including at least one check valve and an axial channel;
providing said inner end of said valve actuator with a stopper;
disposing said inner end of said valve actuator with said stopper into said axial channel with ability to be engaged or disengaged by said pumping piston during the reciprocating movement.

3. The method of automatically maintaining a vehicle's wheel tire properly inflated as defined in claim 1, further including:
transferring the cycling tire deformations to said reciprocating pumping means during the vehicle's travelling;
automatically pumping ambient air through said tire valve using cyclical tire deformations during the vehicle's travelling with a preselected speed when the tire is beginning to become under-inflated.

4. The method of automatically maintaining a vehicle's wheel tire properly inflated as defined in claim 1, wherein said process of ambient air pumping including:
an intake stroke consisting of two steps:
a) creating a partial vacuum in said axial cylindrical bore;
b) opening said valve core and drawing ambient air into said axial cylindrical bore;
a compression stroke consisting of two steps:
a) closing said valve core;
b) compressing said ambient air in said axial cylindrical bore and expelling said ambient air from said axial cylindrical bore into the tire interior.

5. The method of automatically maintaining a vehicle's wheel tire properly inflated as defined in claim 1, further including:
transferring cyclical deformations of the tire peripheral surface during the vehicle's travelling to said reciprocating pumping means.

6. The method of automatically maintaining a vehicle's wheel tire properly inflated as defined in claim 1, further including:
transferring cyclical deformations of the tire peripheral surface during the vehicle's travelling to said reciprocating pumping means by a lever system, said lever system including at least one pushing means pivotable into a substantially radial position by the centrifugal force developed when the wheel rotation exceeds a preselected speed.

7. The method of automatically maintaining a vehicle's wheel tire properly inflated as defines in claim 1, further including:
automatically preventing the tire over-inflating by opening said tire valve only if the tire is under-inflated;
automatically opening said tire valve only during rotation of the wheel with a pre-selected speed.

8. The method of automatically maintaining a vehicle's wheel tire properly inflated as defined in claim 1, further including:
pivoting said pushing means into a substantially horizontal position when the tire being deflated in a case of accident.

9. A tire valve incorporating an air pumping means for automatically maintaining a vehicle's wheel tire properly inflated, said tire valve including:
a valve stem mountable on the wheel's rim, said valve stem having an axial cylindrical bore;
a conventional valve core, such as a Schruder type, mountable in said valve stem, said valve core including a valve actuator for opening and closing said valve core, said valve actuator including an outer end and an inner end;
a reciprocating air pumping means mountable inside of said axial cylindrical bore;
a means for engaging and disengaging said valve actuator by said air pumping means for opening and closing said valve core during the reciprocating movement of the air pumping means.

10. The tire valve as defined in claim 9, wherein:
said air pumping means is a piston disposed in said axial cylindrical bore and including at least one check valve;

11. The tire valve as defined in claim 9, wherein:
said means for engaging said valve actuator by said air pumping means includes a stopper on the inner end of said valve actuator, said stopper being disposed in an axial channel in said piston with ability of the piston's reciprocative movement and engaging said valve activator to open the valve core at the end of the intake stroke, or disengaging said valve activator to close the valve core at the beginning of a compression stroke.

12. The tire valve as defined in claim 9, further including:
a compression spring for moving said pumping means in said axial cylindrical bore during the compression stroke.

13. The tire valve as defined in claim 9, further including:
a means for transferring the tire cyclical deformations said reciprocating pumping means, said transferring means being interposed between said pumping means the tire peripheral surface.

14. The tire valve as defined in claim 13, wherein:
said transferring means comprises a lever system including at least one pushing means interposed between said pumping means and the tire peripheral surface, said pushing means pivoted into a substantially radial operating position by the centrifugal force developed by the rotated wheel when the vehicle exceeds a preselected speed.

15. The method of automatically maintaining a vehicle's wheel tire properly inflated as defined in claim 2 , wherein said process of ambient air pumping including:
an intake stroke consisting of two steps:
a) creating a partial vacuum in said axial cylindrical bore and in said axial channel;
b) opening said valve core and drawing ambient air into said axial cylindrical bore and int said axial channel;
a compression stroke consisting of two steps:
a) closing said valve core;
b) compressing said ambient air in said axial cylindrical bore and in said axial channel, expelling said ambient air from said axial cylindrical bore and from said axial channel into the tire interior.

16. The tire valve as defined in claim 13, wherein:
said transferring means comprises a flexible link.

17. The tire valve as defined in claim 9, further including:
a bracket mountable together with said valve stem on the wheel's rim, said bracket can be used for mounting and protecting said means for transferring the cyclical deformation of the tire to said reciprocating pumping means and for mounting and protecting said compression spring for reciprocating movement of the pumping means during the vehicle operation.

18. An apparatus for automatically maintaining a vehicle's wheel tire properly inflated, including:
a valve stem mountable on the wheel's rim and having an axial cylindrical bore;
a reciprocating air pumping means mountable within said axial cylindrical bore;
a conventional valve core, such as a Schruder type, mountable in said valve stem, said valve core including a valve actuator for opening and closing said valve core, said valve actuator including an outer end and an inner end;
a means for engaging said valve actuator by said air pumping means for opening and closing said valve core during the reciprocating movement of the air pumping means;
a transferring means interposed between said tire valve and a tire sidewall for operating said pumping means by transferring the cyclical deformations of the tire peripheral surface during the vehicle's travelling into the reciprocating movement of said pumping means;

19. The apparatus for automatically maintaining a vehicle's wheel tire properly inflated as defined in claim 18, wherein:
said means for transferring the cyclical tire deformations into reciprocating movement of said pumping means includes a lever system, said lever system includes at least one pushing means interposed between said pumping means and the tire peripheral surface;
said pushing means is pivotable into a substantially radial operating position by the centrifugal force developed by the rotated wheel when the vehicle exceeds a preselected speed;
said a radially oriented pushing means can be biased against the inner peripheral tire surface only when the tire is under-inflated and the part of tire incorporating said tire valve is in contact with the road;
said pivotable pushing means can be pivot into a substantially horizonal position when the tire is flattering in a case of an accident.

20. The apparatus for automatically maintaining a vehicle's wheel tire properly inflated as defined in claim 18, wherein:
said a means for transferring the tire cyclical deformations to said reciprocating pumping means, including:
a lever system for transferring said cyclical tire deformation to move said pumping means in an intake stroke, the tire valve is opened during said intake stroke for drowlng the ambient air into said pumping means;
a resilient means such as a spring to move said pumping means in a compression stroke.
